(19) United States
(12) Patent Application Publication
(10) Pub. No.: US 2009/0031119 A1
(43) Pub. Date: Jan. 29, 2009

(54) Method for the operation of a multiprocessor system in conjunction with a medical imaging system

(75) Inventor: Wieland Eckert, Furth (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 12/220,130

(22) Filed: Jul. 22, 2008

(30) Foreign Application Priority Data
Jul. 25, 2007 (DE) 10 2007 034 684.2

(51) Int. Cl. G06F 9/30

(52) U.S. Cl. 712/225; 712/E09.016

(57) ABSTRACT

The invention relates to a method for operating a multiprocessor system, especially in conjunction with a medical imaging system. The invention also relates to a medical imaging device which is designed to perform this method. The multiprocessor system in this case has at least two processing units, at least one control unit and operations which can be allocated to the processing units. Data provided from an input is processed by the processing unit and made available at an output. The at least one control unit enhances the named data with control data, which defines an allocation of the data to the respective operations for the purposes of processing.

### CROSS REFERENCE TO RELATED APPLICATIONS

This application claims priority of German application No. 10 2007 034 684.2 filed Jul. 25, 2007, which is incorporated by reference herein in its entirety.

### FIELD OF THE INVENTION

The invention relates to a method for operating a multiprocessor system, especially in conjunction with a medical imaging system. The invention also relates to a medical imaging device which is designed to implement this method.

### BACKGROUND OF THE INVENTION

In a typical x-ray system for interventional angiography, a time sequence of x-ray images is generated. The processing of the individual images is always performed in the same way, with certain demands being placed on the speed of the processing. To process an image, algorithms for image improvement are used. These algorithms are implemented in the form of programs which represent a transformation of the image information. The compute-intensive processing of x-ray images can typically not simply be resolved in one single processing unit (CPU, DSP, FPGA, ASIC etc.), but must take place in several steps on several processing units. Normally a pipeline architecture is used for this, in which the entire processing is broken down into individual, sequential steps. The steps can then be allotted to a plurality of processing units, since the processing steps are independent of one another. In this situation each processing step is equipped with a parameter set which controls the relevant processing step. For example, “windowing” is required for the processing step for the reconstruction of the dynamics of the gray-scale values of the parameter set, e.g. consisting of “center, width”. This information is to be supplied to the processing step in suitable form.

In the widespread pipeline architecture the pipelining of processing steps is performed on that data which has to be processed in time sequence. In data pipelining the newly arrived data is assigned to a processing unit (“process”) at discrete points in time, said processing unit calculating a first part of an algorithm or an operation (“program”). After this calculation has been performed the interim result is forwarded to a further processing unit, which then applies the next step of the algorithm to the data. This is repeated multiple times, until all steps have been executed and the final result is available. The number of performance steps thereby executed is described as the “depth” of the pipeline. In other words, an implementation of a pipeline processing consists in regarding the data to be processed as a kind of “stream” which “flows” through the individual processing steps.

FIG. 1 shows an example of such an implementation of pipeline processing. FIG. 1 shows a source Q and a sink S, whereby data is transferred to the sink S from the source Q. Furthermore, a control unit K, also known as a control entity, is shown, which controls the transfer of the data from one processor, e.g. PZ1, to the next, e.g. PZ2. Several processors PZ1 to PZ3 are illustrated, each of which is filled with an algorithm ALGO1, ALGO2, ALGO3. Interfaces to the outside are characterized with IN as input and OUT as output. Parameter sets A1, A2, A3 are made available in individual processing steps by a separate mechanism controlled by the control unit K. For example, the “windowing” can be influenced during ongoing pipeline processing, in that during the processing a new or changed parameter set of the processing stage is provided. The parameter sets which are stored as control information in control data must be synchronized with the (useful) data flow. This ensures that a particular parameter change should occur as of a particular data set, for example the n-th. Such a synchronization in the previous pipeline architecture requires a special knowledge of the topology of the entire processing system. Accordingly the higher-level control unit must be informed at every point in time which data set number is currently in which processing unit. In this way a changed parameter set can be indicated at the right time. A further drawback of this type of implementation is that an additional processing step cannot easily be inserted. To do this, the control unit requires information about the changed processing duration. It is similarly difficult to bring about a change in the granularity of the processing data. If, for example, a processing step performs a line-based algorithm but the next processing step operates on data consisting of three lines (e.g. implementation of a triple kernel), then in additional to buffering the data within the pipeline a delay in the application of the parameter sets also has to be taken into account. Such difficulties are currently resolved in that they are either ignored (a changed parameter set acts immediately on the next datum), or the application as of the next meaningful data structure (different granularity e.g. on a pixel or line basis) is to take place via a higher level item of information (for example a frame number).

### SUMMARY OF THE INVENTION

It is the object of the invention to overcome the aforementioned disadvantages.

The object is achieved by the features given in the independent claims. Advantageous developments of the invention are given in the dependent claims.

An essential aspect of the invention consists of a method for operating a multiprocessor system, especially in conjunction with a medical imaging system. This system includes at least two processing units, at least one control unit and operations that can be allocated to the processing units. By means of the processing units, data from an input is processed and made available at an output. The at least one control unit enhances the named data with control data which determines the allocation of the data to the respective operations for the purposes of processing.

Advantageously, the respective operations are allocated by the at least one control unit to the processing units. It can be useful if the allocation of the data to the respective operations is defined or controlled by a predetermined sequence.

A sequential or parallel processing of data is possible. Thus, at least one further processing unit or an available processing unit, to which at least one operation is allocated, can be used for processing the data.

Advantageously, the data allocated from the input will include useful data and control data, with it being possible for the control data to be advantageously arranged in a “header”.

The control data is adapted during or after a processing by at least one operation assigned to a processing unit. This enables the specification of a renewed or repeated allocation of the data to the respective operation.

Advantageously, the data is cyclically allocated to the respective operations and processed.

Multicore processors or cluster processors, multi DSP configurations, cell processors, stream processors or freely-programmable logical modules are conceivable as a multiprocessor system.

A further embodiment of the invention exists in that the processing units, to which operations are allocated, exchange the data through at least one common memory unit.

It is also conceivable for the data to be exchanged through at least one common connection network in addition to, or instead of, through a common memory unit.

The connections between the processing units can be switched either statically or dynamically through the at least one connection network.

The data exchange can also take place in the form of data packets via the at least one connection network.

The allocation of the data can be either event controlled or time controlled.

A processing pool, also called a worker pool, can also be used. In this case a scheduler controls the allocation of the data to one of the processing units.

A further aspect of the invention is a medical imaging device, and its embodiments, designed to perform the inventive method. By means of a device, there can expediently be a connection network between the processing units, whereby the connections can be switched either statically and/or dynamically.

The invention has the following advantages:

The following advantages are achieved by the enhancement of the useful data by complete control data:
A simple synchronization of the control data with the useful data at each point in the processing pipeline,
The possibility of expanding the processing system with additional processing steps, including in the pipeline processing,
The possibility of setting up a non-linear topology (processing network, splitting and renewed combining),
A calculation in “processing cells” is no longer specialized so that it has to be carried out at exactly one processing step,
A possibly more flexible division of the processing times compared with the conventional precisely clocked processing model,
The enabling of an implementation of algorithms controlled by convergence criteria (i.e. control by convergence and computing time, the number of loop runs is not specified from the start),
The possibility of using non-specialized processing units,
Modular expandability if greater data rates are necessary. This means that additional processing units can be used with the latencies being retained,
The possibility of using both specialized and universal processing sources,
Flexible physical topology, preferably star-shaped, with the logic (preferably linear) topology being configurable.

### BRIEF DESCRIPTION OF THE DRAWINGS

The invention is described in more detail in the following by means of one or more exemplary embodiments and with reference to the drawings. The drawings are as follows:

FIG. 1 A typical pipeline architecture according to the prior art, mentioned in the introduction,

FIG. 2 An example of the inventive enhancement of the useful data stream by control data,

FIG. 3 An inventive embodiment of the data processing with a common memory,

FIG. 4 An inventive embodiment of the data processing by means of a connection network.

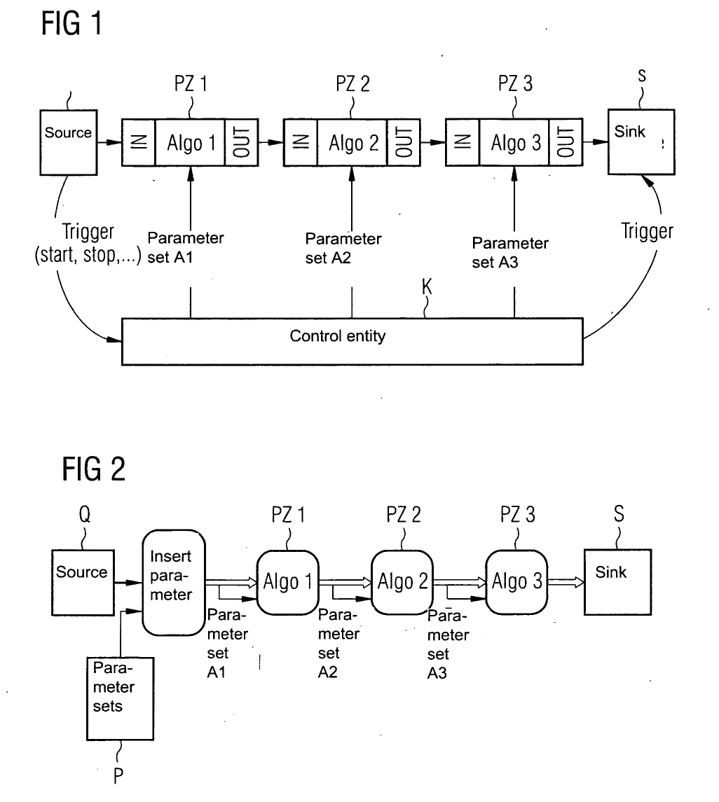

In FIGS. 2, 3 and 4, the same components are mainly given reference characters corresponding to those used in FIG. 1.

### DETAILED DESCRIPTION OF THE INVENTION

FIG. 2 shows a pipeline architecture according to the invention with the parameter sets P being added to the useful data as control data, e.g. A1, A2 or A3 and with the data stream being “extended” from one processing unit PZ1 or PZ2 (processor) to the next processing unit PZ2 or PZ3. In the illustrations, the control data A1, A2, A3, shown merely by a separate arrow next to the data stream arrow, is adapted after each processing step, e.g. Algo 1, Algo 2, Algo 3 and transferred to the next processing step.

As stated above, not only is the necessary input data or useful data (pixels, gray-scale values) represented in the data structures for pipeline processing, but also the parameter sets for the succeeding processing stages of the pipeline are entered in a separate and additional structure element. In this way, the input data is enhanced by the control unit with instructions, at a separate point e.g. in the header, for further processing, and the following processing steps can also be performed without a further connection to the control unit regardless of their respective processing steps. The complete processing is data driven and therefore more or less asynchronous. In other words, not only the actual useful data, but also the control data, is received as an input data set at each processing stage. The processing step can extract the parameter set necessary for this step from the control data and apply it to the input data or useful data according to the algorithm and thus create the output data. Further processing then takes place as already described.

The advantage of this method is that expensive and error-prone synchronization of the control unit with the individual processing steps is completely omitted. The parameter sets are linked directly to the useful data at each timepoint and are available for the respective processing step.

A further advantage is that a strict pipeline architecture can generally be reduced to a “cell architecture”. With the pipeline architecture, precisely one algorithm is applied to the data by each processing unit, with the processing steps being specially designed for this algorithm and operating in a fixed predetermined clock cycle. In the cell architecture which is now possible, a processing cell can, e.g. on the basis of criteria of the permitted processing time duration, decide to perform several steps, including steps of various algorithms. Iterative algorithms can, for example, be more easily realized in this way.

If a data set permits a shorter processing time, for example because convergence conditions can be very quickly fulfilled, this processing step can also be completed more quickly. If in turn the same data set requires somewhat longer to process in the next processing step, the next processing step can also take up more processing time. This results in an asynchronous processing model compared with the previously predominantly strictly-timed processing schedule.

In particular, the parametering of these processing steps, which are now of variable length, can be more easily performed with this inventive approach. The cell based processing thus enables a greater amount of algorithms to be implemented than would have been possible with a timed pipeline processing. In this way, there can be more algorithms than processors, with it being possible to assign several algorithms to one processor.

With regard to a simplified implementation, a logical processing chain is also considered, with other topologies, (e.g. branchings, reassemblings etc.) also being conceivable.

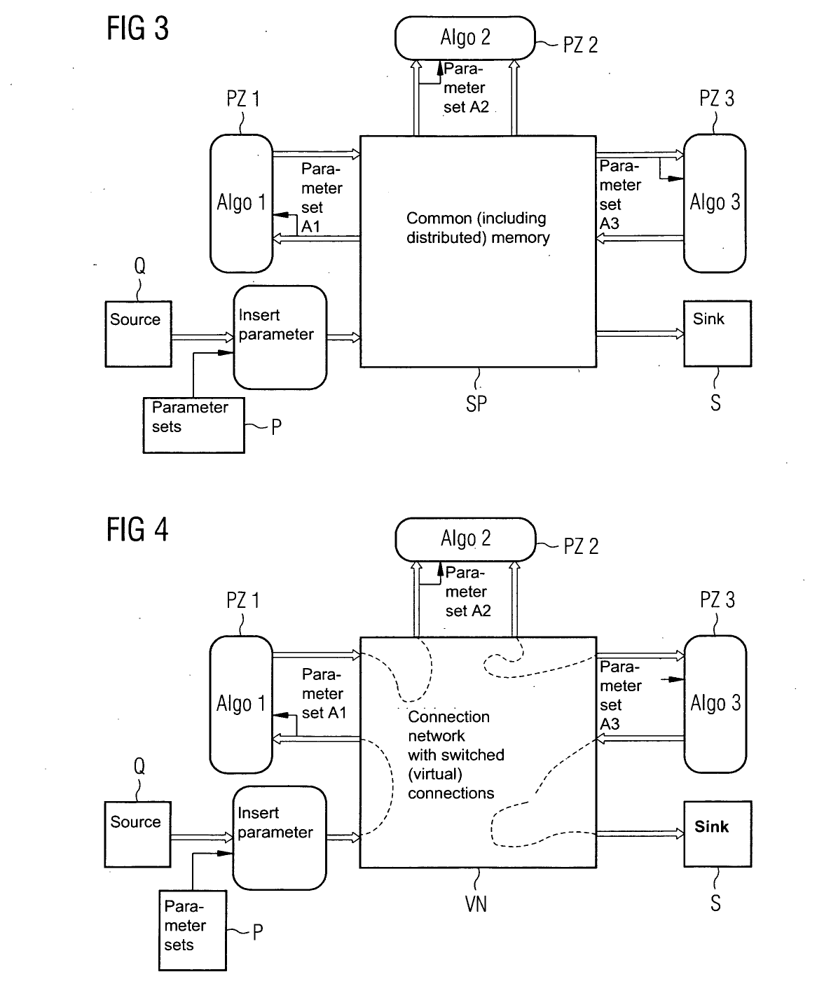

On the basis of the combined structure of useful data and control data, a processing method, based on a“blackboard” model, with at least one common memory SP as shown in FIG. 3, can be used. In this case, the data is “published” in a common memory SP. A free processing unit (e.g. PZ1) now reacts to such open work jobs, in that it accepts the data, applies the next processing step to the useful data on the basis of the provided control data and again stores the result, marked with the additional mark of the processing step that has now been carried out, in the common memory. This procedure can be implemented on an event-controlled basis. It can also be realized by a processing pool, called a “worker pool”. In this case, a so-called scheduler controls the allocation of the work job to one of the processing units.

A main advantage of this model is that the algorithm and processor (or processing unit) are now decoupled from each other. This means that not only is sequential processing possible but also parallel processing. Available processors or other processors can be used to expand the processing of the data, in that the algorithms are assigned depending on the type of processor (capacity, capabilities) to the different processors (e.g. DSP, cell, multicore, cluster processors, stream processors or FPGA). As can be seen in FIG. 4, the schematic representation can, for example, be expanded by a processor, e.g. PZ4 following processor PZ3, with an algorithm Algo 4.

A further processing model can be realized in that the data instead of being additionally or alternatively stored in a common memory, as shown in FIG. 4, can be transported by a common connection network VN. This can be regarded as an embodiment of the common memory (“blackboard” model), with only output and input data that is in each case commonly used in pairs being modeled. Because the dynamic reconfigurability of a hierarchical “packet switched network” is used, almost the same flexibility can be achieved as by the aforementioned “blackboard” model. The switching to a processing unit can be realized by sending “multitask” packets. The desired topology (frequently linear) is usually defined in advance and switched by the network.

1.-18. (canceled)

19. A method for operating a multiprocessor system comprising a plurality of processing units, comprising:
assigning a control unit to the processing units;
assigning a plurality of operation algorithms to the processing units respectively for processing a plurality of data;
allocating the data to the operation algorithms respectively;
inserting a plurality of control data to the data respectively by the control unit; and
defining the allocation of the data based on the inserted data.

20. The method as claimed in the claim 19, wherein the allocation of the data is defined by a predetermined sequence.

21. The method as claimed in the claim 19, wherein the control unit assigns the operation algorithms to the processing units.

22. The method as claimed in the claim 19, wherein the data is sequentially or parallel processed based on the allocation of the data.

23. The method as claimed in the claim 19, wherein a further processing unit is dynamically added and is assigned to a further operation algorithm for processing the data.

24. The method as claimed in the claim 19, wherein the control data is inserted to the data during or after processing for specifying a renewed or repeated allocation of the data to the operation algorithms.

25. The method as claimed in the claim 19, wherein the data is cyclically timed applied to the operation algorithms for processing.

26. The method as claimed in the claim 19, wherein the multiprocessor system comprises a system selected from the group consisting of: a multi-core processing unit, a cluster computer, a multi-DSF configuration, a cell processor, a stream processor, and a freely programmable logistics module.

27. The method as claimed in the claim 19, wherein the processing units exchange the data through a common memory unit.

28. The method as claimed in the claim 19, wherein the processing units exchange the data through a common connection network.

29. The method as claimed in the claim 19, wherein the processing units exchange the data via a data packet.

30. The method as claimed in the claim 19, wherein the processing units are connected to each other and statically switched by a connection network.

31. The method as claimed in the claim 19, wherein the processing units are connected to each other and dynamically switched by a connection network.

32. The method as claimed in the claim 19, wherein the allocation of the data is event controlled.

33. The method as claimed in the claim 19, wherein the allocation of the data is scheduledly controlled.

34. The method as claimed in the claim 19, wherein the processing units process the data applied from inputs and output the processed data at outputs for further processing.

35. The method as claimed in the claim 19, wherein the multiprocessor system is used in a medical imaging system.

36. A medical device with a multiprocessor system, comprising:
a plurality of processing units; and
a control unit that:
assigns a plurality of operation algorithms to the processing units respectively for processing a plurality of data allocated to the operation algorithms respectively, and
inserts a plurality of control data to the data respectively for defining the allocation of the data.
